(19) United States
(12) Patent Application Publication
(10) Pub. No.: US 2026/0238978 A1
(43) Pub. Date: Aug. 13, 2026

(54) METHODS FOR LOCKING AN EMERGENCY CALL SESSION

(71) Applicant: T-Mobile Innovations LLC, Overland Park, KS (US)

(72) Inventor: Manikanta Kumar Teja PENUMATSHA, Redmond, WA (US)

(21) Appl. No.: 19/052,583

(22) Filed: Feb. 13, 2025

(51) Int. Cl. H04W 4/90; H04M 3/436

(52) U.S. Cl. CPC H04W 4/90; H04M 3/436

(57) ABSTRACT

Methods are provided for initiating a call session between a wireless device and an external communication device, receiving, at a wireless core network, a request to lock the call from the wireless device, and blocking, at the wireless core network, incoming calls to the wireless device during the call with the blocking occurring responsive to receiving the request to lock the call.

### TECHNICAL BACKGROUND

Cellular phones, such as smartphones, are often used to make important telephone calls, including contacting emergency services. In some instances, the emergency service is contactable by a public safety answering point (PSAP). During an important call, in some instances, another call may be transmitted to the cellular phone, resulting in a notification, which may be audible, visual, or both, at the cellular phone. In responding to the notification, a user of the cellular phone may accidentally engage with the emergency call session. This engagement can be relatively minor but may inadvertently end the important call session when trying to respond to the notification. This unintentional interaction with the call session may result in important information being miscommunicated or missed entirely. In circumstances where the important call is an emergency call session, this missing or miscommunicated information between the user and a PSAP operator may affect emergency service response.

### OVERVIEW

Exemplary embodiments described herein include methods for locking an emergency call session. An exemplary method includes initiating an call session between a wireless device and an external communication device. The method then includes receiving a request to lock the call from the wireless device, with the request received at a wireless core network. The method further includes blocking incoming calls to the wireless device during the call. The blocking occurs at the wireless core network and is responsive to receiving the request to lock the emergency call.

Another example method includes receiving a request from a wireless device to lock an emergency call session between the wireless device and a public service access point (PSAP), where the request is received at a wireless core network. The method then includes receiving, at the wireless core network for the wireless device. The call request is received during the emergency call session. The method further includes declining, at the wireless call network, transmission of the call request to the wireless device.

A further example method includes initiating an emergency call session between a wireless device and a public safety access point (PSAP). The method then includes receiving, at the wireless device, activation of a call lock option. The method further includes transmitting a call lock notification for the wireless device to a wireless core network. The call lock notification is transmitted in response to activation of the call lock option.

### BRIEF DESCRIPTION OF THE DRAWINGS

FIG. 1 illustrates an exemplary system for wireless device communication in accordance with disclosed embodiments.

FIG. 2 illustrates an additional exemplary system for wireless device communication with an external communication device in accordance with disclosed embodiments.

FIG. 3 illustrates an example method for locking a call session in accordance with disclosed embodiments.

FIG. 4 illustrates another example method for locking a call session in accordance with disclosed embodiments.

FIG. 5 illustrates another example method for locking a call session in accordance with disclosed embodiments.

### DETAILED DESCRIPTION

Wireless devices are increasingly used to make and receive important calls. These calls may include, for example, emergency calls, calls with healthcare institutions, work-related calls, and many other types of calls that a user may deem important. In particular, when an emergency call, such as a call to 911, is made, a public safety access point (PSAP) receives the call. The PSAP is connected to a variety of emergency services, such as police, fire, and emergency medical service (EMS), and as such, the PSAP is able to coordinate aid to the caller based on information collected during the emergency call.

In instances where an important call is made by a wireless device, such as a smartphone, subsequent calls made to the wireless device do not receive a traditional “busy signal” to indicate that the wireless device is in use. Instead, the user is alerted to the subsequent call or, in some examples, the call is automatically routed to voicemail, and the user is notified of the existence of a voicemail message.

When the user is alerted to the subsequent call, the details of the call are presented on the screen of the wireless device, along with options to respond to the call. One option may be to hold the important call to allow the user to answer the subsequent call. Another option may be to decline the subsequent call and remain on the important call. Each option requires the user to interact with the wireless device to select the desired option, distracting the user from the important call. In examples where the important call is an emergency call, distractions may result in the user and/or the PSAP operator missing important information pertaining to the circumstances that led to the emergency call. In examples where the important call is not an emergency call, the potential for missed information means that a user may miss information from an operator or may miss requests from the operator. Further, in some examples, the user may accidentally disconnect the important call session while interacting with the wireless device to respond to the subsequent call alert. While the external communication device, whether a PSAP or other, is able to perform a return call to the wireless device, returning a call takes time and, in circumstances where the user is interacting with the subsequent call, may result in the return call being declined.

Exemplary embodiments described herein relate to methods for locking a call session. For example, when s call is established between a wireless device and an external communication device, the wireless device may receive an option to lock the call session. The option may be presented as a notification that appears on the screen of the wireless device which permits the user to engage with the presented option. When a user affirmatively opts to engage the call lock option, the wireless device may transmit this selection to a wireless core network, along with identifying information corresponding to the wireless device. Upon receiving the notification, the wireless core network can preemptively block subsequent calls to the identified wireless device for the duration of the call session. More particularly, when a subsequent call is attempted to the wireless device during the call session, the subsequent call will pass through the wireless core network. However, when the wireless core network has received a call lock notification for the wireless device, the wireless core network will decline to allow the subsequent call to continue to the wireless device. Instead, the wireless core network will log the subsequent call.

As a result of declining the subsequent call at the wireless core network, the wireless device does not receive notification of the subsequent call during the call session, allowing the user to have their full focus on the call. Once the call session is terminated, the wireless core network will send the log of subsequent calls, allowing the user to see who attempted to speak with them during the call session. As a result, the user is able to focus on the conversation during the call session without risking accidental interaction or disconnection but will still know who attempted to contact them during that call session.

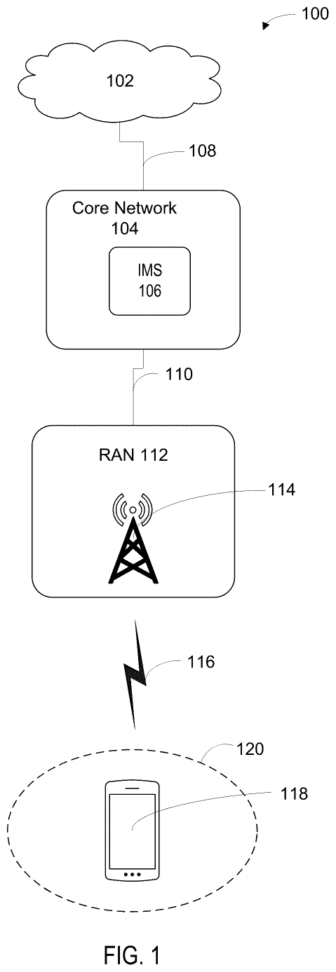

These and other examples will be described in greater detail below in relation to FIGS. 1-5.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes a wireless device 118, which may be an end-user wireless device and may operate within a coverage area 120. The wireless device 118 may communicate with an access node 114 within the RAN 112 over a communication link 116.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless device 118. Wireless network protocols can comprise Fifth Generation mobile networks or wireless systems (4G or 4G LTE) or 5G. Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

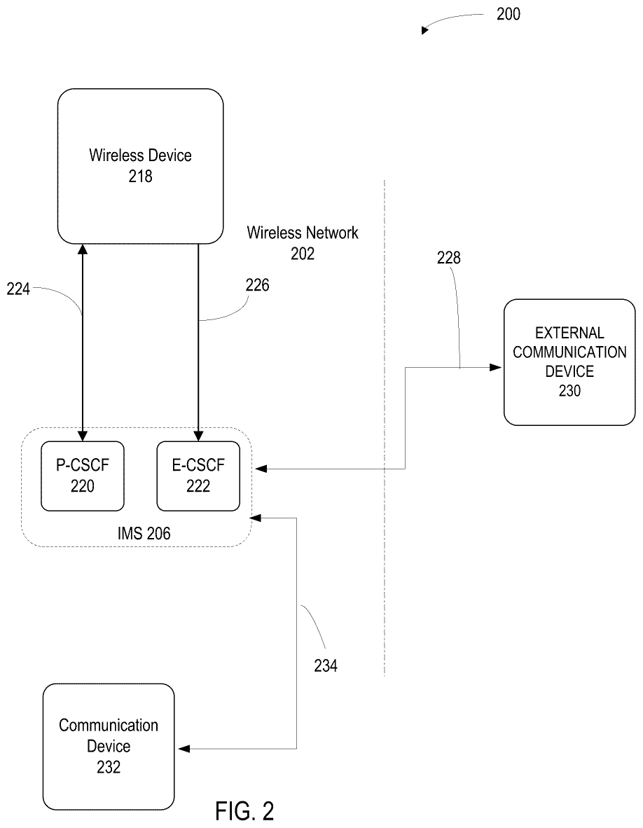

The core network 104 includes the IP Multimedia Subsystem (IMS) 106, which will be explained further in relation to FIG. 2. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the wireless device 118.

Core network 104 may include an IP multimedia subsystem (IMS) 106. IMS 106 as used herein is a framework used for delivering IP multimedia services, such as voice over internet protocol (VoIP) and/or other similar services, across a network. IMS 106 may include a call session control function (CSCF). The CSCF as used herein is a component of IMS 106 used for session control, signaling and routing in multimedia communication. In embodiments, the CSCF may be used for handling session initiation protocol (SIP) communication. In embodiments, IMS 106 may be used for communication between entities or components of network 102 and wireless device 118. For example, the CSCF of the IMS 106 may be used for transmitting SIP communication to wireless device 118 and a PSAP. Communication links 108 and 110 can use various communication media, such as air, space, metal, optical fiber, or some other signal propagation path-including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the end-user wireless device 118. Components of the RAN 112 may communicate directly with the core network 104 and others may communicate directly with the end user wireless device 118. The RAN 112 may provide services from the core network 104 to the end-user wireless device 118.

The RAN 112 includes an access node (or base station) 114, which may include one or more access nodes communicating with the end-user wireless device 118. It should be understood that the disclosed technology may also be applied to communication between an end-user wireless device and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 106 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 118 may include any wireless device included in a wireless network. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless device 118 may be any device, system, combination of devices, or other such communication platform capable of communicating wirelessly with access node 114 using one or more frequency bands and wireless carriers deployed therefrom. Wireless device 118 may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless device 118 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless device 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the RAN 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for locking an emergency call session may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

Now referring to FIG. 2, an exemplary system 200 for locking an emergency call session is presented. System 200 includes a wireless device 218. Wireless device 218 may be the same as wireless device 118. System 200 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

External communication device 230 may be a wireless device, similar to wireless device 218, or may be another type of device able to make calls and connect to wireless device 218 at the IMS 206. In examples, the external communication device 230 may be a public safety access point (PSAP).

The IMS 206 includes may include servers, including a proxy call session control function (P-CSCF) 220 and an emergency call session control function (E-CSCF) 222, shown, but it should be understood that there are many other types of IMS and core servers that are omitted for clarity. In an embodiment, a proxy server, such as P-CSCF 220 receives a call request from a wireless device 218, as shown by arrow 224. Headers may be added to the call request in the form of SIP headers such as Resource Priority Header (RPH), X-MAV-RPH: 911, Orig. ID, and Attestation-Info. The call request may be a request to contact external communication device 230. While external communication device 230 is shown as external to wireless network 202, external communication device 230 may be within the same wireless network 202 as wireless device 218.

When a call request is made, the P-CSCF 220 may query a gateway mobile location center (GMLC) for information about the destination network of the call. In such examples, the GMLC returns information about the destination network, including information about how to contact the external communication device 230. The wireless device 218 is then connected to the external communication device 230. The external communication device 230 may use SIP trunking to connect to IMS 206, which allows the external communication device 230 to send and receive voice and multimedia data over an IP network, as shown by arrow 228. External communication device 230 may use SIP and session description protocol (SDP) for managing session and session parameters.

In examples where the external communication device 230 is a PSAP, the call request may first be forwarded to an emergency call management server such as E-CSCF 222 for further processing, as shown by arrow 226. The E-CSCF 222 may query the GMLC for information about the destination network of the call, and the GMLC may return information on a PSAP that services the location of the wireless device 218 that originated the call request. This information includes how to contact the PSAP. The wireless device 218 is then connected to the PSAP.

In addition, system 200 may include a second communication device 232. Second communication device 232 may be a wireless device, similar to wireless device 218, or may be another type of device able to make calls and connect to wireless device 218 via a request at the IMS 206, as shown by arrow 234. Second communication device 232 may be part of the same wireless network 202 as wireless device 218, as shown in FIG. 2; however, examples are not so limited and the second communication device 232 may be external to wireless network 202, i.e., may be part of a different wireless network.

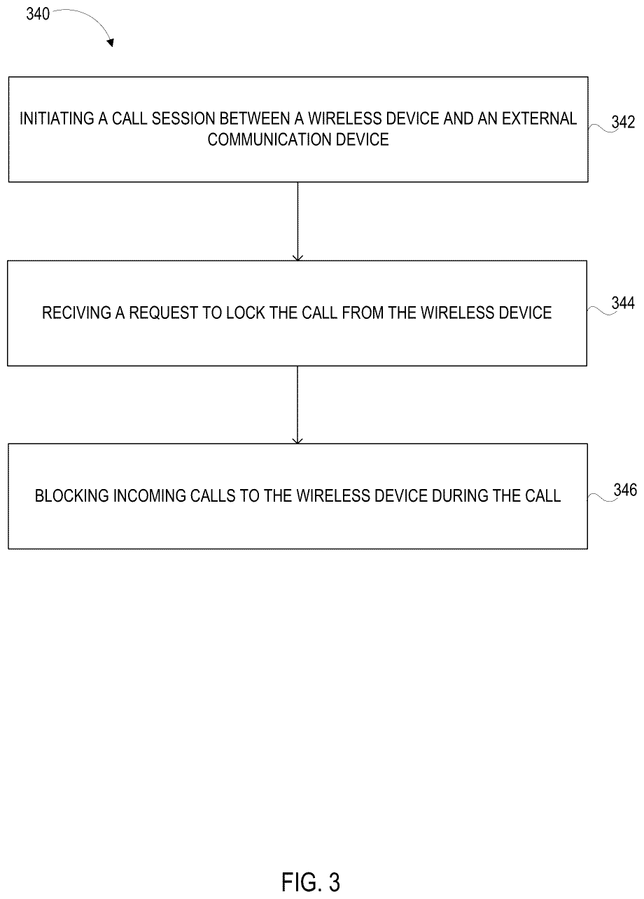

FIG. 3 illustrates an example method 340 for locking a call session in accordance with disclosed embodiments. Method 340 may be performed by any suitable combination of processors discussed herein, for example a processor contained in an IMS, such as a P-CSCF server.

Method 340 begins in step 342 where a call session is initiated between an external communication device and a wireless device. The call session may be transmitted via a wireless network, which may be hosted by a mobile network operation (MNO). In some examples, the emergency call is a session initiation protocol (SIP) invite. In embodiments, the CSCF transmits an SIP INVITE from the wireless device 218 to the external communication device 230 or vice versa. In embodiments, the SIP INVITE may include session description protocol (SDP) parameters that establishes an IMS DC for the session.

Method 340 continues in step 344 where a wireless core network receives a request from the wireless device to lock the call. More particularly, the request to lock the call may be received from the wireless device at an IP multimedia subsystem (IMS) of the wireless core network. The request to lock the call may occur in response to initiating a call session at step 342. In some examples, the request to lock the call may be received at the wireless core network in response to a user interacting with a notification or a button on the wireless device, allowing the user to affirmatively designate the call as “important”. In other examples, particularly when the call session initiated at step 342 is an emergency call session the request to lock the call may be received at the wireless core network automatically in response the status of the call as an emergency call.

The request to lock the call session received at the wireless core network may include information corresponding to the identity of the wireless device, allowing the wireless core network to lock the call session for a particular wireless device. For example, the request may include information such as a call identification, a Mobile Station International Subscriber Directory Number (MSISDN), and an International Mobile Equipment Identity (IMEI). Such identification information may allow the wireless core network to confirm that the wireless device on the call session is the wireless device for which the wireless core network will lock the call session.

Method 340 continues in step 346 with blocking incoming calls to the wireless device during the call session. Incoming calls may be blocked at step 346 in response to the wireless core network receiving the request to lock the call at step 344. Said differently, upon receiving the request to lock the call from the wireless device at step 344, the wireless core network may block incoming calls to the wireless device while the call session is ongoing.

In some examples, blocking an incoming call at step 346 may include receiving a subsequent call request for the wireless device at the wireless core network. The subsequent call request may be transmitted by a second communications device, such as device 232, described with respect to FIG. 2. Upon receiving the subsequent call request, the wireless core network may decline the subsequent call request. The caller making the subsequent call request may hear a busy signal to indicate that the call request was successfully transmitted but not received at the wireless device.

Declining the subsequent call request may include logging the subsequent call request at the wireless core network. The log may include the telephone number making the subsequent call request, the time the call request was made, and additional identifying information, such as a contact name.

Method 340 may further include terminating the call session between the wireless device and the external communication device. In response to the call session being terminated, method 340 may include transmitting a call log from the wireless core network to the wireless device. The call log may include at least one attempted call to the wireless device, with the at least one attempted call occurring during the call session. In some examples, the call log may consist of calls logged in response to the wireless core network blocking incoming calls to the wireless device during the call session at step 346. This allows the user to see the missed or attempted calls so that the user can manage the calls after the call session has been terminated.

In some examples, terminating the call session may further comprise unblocking incoming calls to the wireless device. The unblocking may occur at the wireless core network such that any subsequent call requests received for the wireless device at the wireless core network are permitted to reach the wireless device.

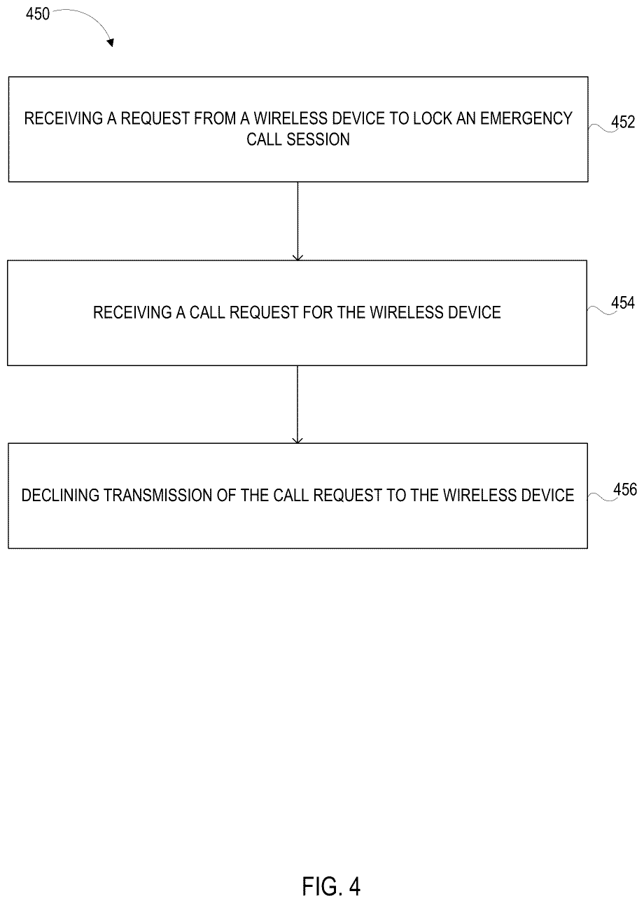

FIG. 4 illustrates another example method 450 for locking a call session in accordance with disclosed embodiments. Method 450 may be performed by any suitable combination of processors discussed herein, for example a processor contained in an IMS, such as an E-CSCF server.

Method 450 begins at step 452 with a wireless core network receiving a request from a wireless device to lock an emergency call session. The emergency call session may be established between the wireless device and a public safety access point (PSAP), such that the request to lock the emergency call session received at the wireless core network may be a request to lock the active and established session. The wireless core network may be an IP multimedia subsystem (IMS), such that the request to lock the emergency core session is received at the IMS of the wireless core network.

The request to lock the emergency call session may include receiving, at the wireless core network, identification information corresponding to the wireless device. The identification information may be at least one of a call identification, a Mobile Station International Subscriber Directory Number (MSISDN), and an International Mobile Equipment Identity (IMEI). Such identification information may allow the wireless core network to confirm that the wireless device on the emergency call session is the wireless device for which the wireless core network will lock the emergency call session.

At step 454, method 450 includes receiving a call request for the wireless device. The call request may be received at the wireless core network and may be received from a communications device such as communications device 232, described with respect to FIG. 2. In some examples, the call request received at step 454 may be received during the emergency call session.

At step 456, method 450 includes declining transmission of the call request to the wireless device. The call request may be declined at the wireless core network. In some examples, the wireless core network may store a record of the call request upon declining to transmit the call request at step 456. The record of the call request may include identifying information for the device making the call request, such as a telephone number or contact information, as well as the time at which the call request was received at the wireless core network.

Method 450 may further include transmitting the record of the call request from the wireless core network to the wireless device. The record of the call request may correspond to the record of the call request made responsive to declining transmission of the call request at step 456. In some examples, the wireless core network may transmit the record of the call request to the wireless device in response to the emergency call session between the wireless device and the PSAP being terminated. That is, upon receiving an alert that the wireless device is no longer active in the emergency call session, wireless core network may transmit the record of the call request to the wireless device to allow the wireless device to see the calls attempted while the emergency call session was locked in response to receiving the request to lock the emergency call session at step 452.

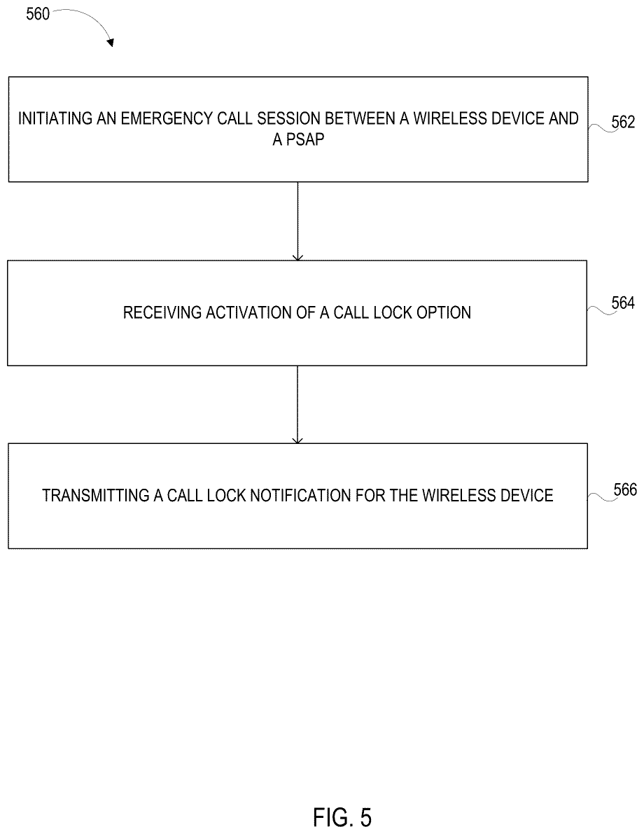

FIG. 5 illustrates still another example method 560 for locking an emergency call session in accordance with disclosed embodiments. Method 560 may be performed by any suitable combination of processors discussed herein, for example a processor contained in an IMS, such as an E-CSCF server.

Method 560 begins at step 562 with initiating an emergency call session between a wireless device and a public safety access point (PSAP). The emergency call session may be transmitted via a wireless network, which may be hosted by a mobile network operation (MNO). In some examples, the emergency call is a session initiation protocol (SIP) invite. In embodiments, the CSCF transmits an SIP INVITE from the wireless device 218 to the PSAP 230 or vice versa. In embodiments, the SIP INVITE may include session description protocol (SDP) parameters that establishes an IMS DC for the session.

Method 560 continues in step 564 with receiving activation of a call lock option. The call lock option may be received at the wireless device and may be received in response to initiation of an emergency call session at step 562. In some examples, the call lock option may be a notification received at the wireless device, such that activation of the call lock option at step 564 includes an affirmative selection of the call lock option at the wireless device. Said differently, receiving activation of a call lock option at step 564 may include interaction by a user with the received call lock option. The interaction may correspond to an affirmative selection option, with affirmative selection activating the call lock option at step 564.

At step 566, method 560 includes transmitting a call lock notification for the wireless device to a wireless core network. In some examples, transmitting a call lock notification at step 566 may comprise transmitting a call lock notification to an IP Multimedia Subsystem (IMS) of the wireless core network. The call lock notification may be transmitted in response to receiving activation of a call lock option at step 564 and may more particularly be transmitted in response to the affirmative selection of the call lock option, notifying the wireless core network of the call as being a locked call. In some examples, transmitting a call lock notification to a wireless core network may include transmitting identification information corresponding to the wireless device to the wireless core network. By transmitting identification information as part of the call lock notification for the wireless device, the wireless core network is enabled to confirm the identity of the wireless device to which the call lock notification is to be applied.

Transmitting a call lock notification to the wireless core network at step 566 may also include transmitting a notification to the wireless core network to decline subsequent calls to the wireless device during the emergency call session. The subsequent calls may be declined at the wireless core network such that the wireless device does not receive any notification of subsequent calls during the emergency call session.

In some examples, method 560 may further include receiving, at the wireless device, a record of a call request from the wireless core network. The record of the call request may correspond to a call request made subsequent to transmission of the call lock notification at step 566. Said differently, the wireless core network, upon being instructed to decline subsequent calls at the wireless core network as part of the transmission of the call lock notification at step 566, may receive a call request, with the call request being intended for the wireless device. Because the wireless core network has been instructed to decline subsequent call requests during the emergency call session, the wireless core network may decline the call request.

As part of declining the call request, the wireless core network may log the details of the call request, allowing any subsequent call requests to be recorded at the wireless core network. This record may be received at the wireless device. In some examples, the record of the call request may be received at the wireless device in response to termination of the emergency call session between the wireless device and the PSAP.

In some embodiments, methods 340, 450 and 560 may include additional steps or operations. Furthermore, the methods may include steps shown in each of the other methods. As one of ordinary skill in the art would understand, the methods of 340, 450 and 560 may be integrated in any useful manner and the steps may be performed in any useful sequence.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, comprising:
initiating a call session between a wireless device and an external communication device;
receiving, at a wireless core network, a request to lock the call from the wireless device; and
responsive to receiving the request to lock the call, blocking, at the wireless core network, incoming calls to the wireless device during the call.

2. The method of claim 1, wherein blocking incoming calls to the wireless device further comprises:
receiving, at the wireless core network, a subsequent call request for the wireless device; and
declining the subsequent call request at the wireless core network.

3. The method of claim 2, wherein declining the subsequent call request at the wireless core network further comprises logging, at the wireless core network, the subsequent call request.

4. The method of claim 1, further comprising:
terminating the call session; and
responsive to terminating the call session, transmitting a call log from the wireless core network to the wireless device.

5. The method of claim 4, wherein the call log includes at least one attempted call to the wireless device that occurred during the call session.

6. The method of claim 4, wherein terminating the call session further comprises unblocking, at the wireless core network, incoming calls to the wireless device.

7. The method of claim 1, wherein a request to lock the call from the wireless device is received at the wireless core network responsive to initiating the call session.

8. The method of claim 1, wherein receiving, at a wireless core network, a request to lock the call from the wireless device further comprises receiving identification information corresponding to the wireless device.

9. A method, comprising:
receiving, at a wireless core network, a request from a wireless device to lock an emergency call session between the wireless device and a public service access point (PSAP);
receiving, at the wireless core network, a call request for the wireless device during the emergency call session; and
declining, at the wireless core network, transmission of the call request to the wireless device.

10. The method of claim 9, further comprising storing, at the wireless core network, a record of the call request.

11. The method of claim 10, further comprising transmitting the record of the call request from the wireless core network to the wireless device, wherein the record of the call request is transmitted in response to terminating the emergency call session.

12. The method of claim 9, wherein receiving a request from a wireless device to lock an emergency call session further comprises receiving identification information corresponding to the wireless device.

13. The method of claim 12, wherein the identification information is at least one of a call identification, a Mobile Station International Subscriber Directory Number (MSISDN), and an International Mobile Equipment Identity (IMEI).

14. The method of claim 9, wherein the wireless core network is an IP multimedia subsystem (IMS).

15. A method, comprising:
initiating an emergency call session between a wireless device and a public safety access point (PSAP);
receiving, at the wireless device, activation of a call lock option; and
responsive to activation of the call lock option, transmitting a call lock notification for the wireless device to a wireless core network.

16. The method of claim 15, further comprising receiving, at the wireless device, a record of a call request from the wireless core network, wherein the call request was made subsequent to transmission of the call lock notification.

17. The method of claim 16, wherein the record of the call request is received at the wireless device responsive to termination of the emergency call session.

18. The method of claim 15, wherein activation of the call lock option comprises an affirmative selection option at the wireless device.

19. The method of claim 15, wherein activation of a call lock option is received in response to initiating the emergency call session.

20. The method of claim 15, wherein transmitting a call lock notification comprises transmitting a notification to decline subsequent calls at the wireless core network during the emergency call session.
